(19) United States
(12) Patent Application Publication
(10) Pub. No.: US 2026/0063954 A1
(43) Pub. Date: Mar. 5, 2026

(54) PIXEL STRUCTURE

(71) Applicant: AUO Corporation, Hsinchu City (TW)

(72) Inventors: Chia-Chun Hsu, Hsinchu City (TW); Guang Fu Wang, Hsinchu City (TW); Yu-Ping Kuo, Hsinchu City (TW); Chao-Chien Chiu, Hsinchu City (TW)

(73) Assignee: AUO Corporation, Hsinchu City (TW)

(21) Appl. No.: 19/278,818

(22) Filed: Jul. 24, 2025

(30) Foreign Application Priority Data
Aug. 27, 2024 (TW) 113132136

(51) Int. Cl. G02F 1/1362

(52) U.S. Cl. CPC G02F 1/136209; G02F 1/136286

(57) ABSTRACT

A pixel structure includes a substrate, a light-shielding layer, a first insulating layer, a semiconductor layer, a second insulating layer, a first conductive layer, a third insulating layer, and a second conductive layer. By dividing the light-shielding layer into a plurality of separated portions, crosstalk between different signals can be reduced.

### CROSS-REFERENCE TO RELATED APPLICATION

This application claims the priority benefit of Taiwan application serial no. 113132136, filed on Aug. 27, 2024. The entirety of the above-mentioned patent application is hereby incorporated by reference herein and made a part of this specification.

### BACKGROUND

### Technical Field

The disclosure relates to a pixel structure.

### Description of Related Art

The contrast ratio (CR) refers to the ratio between the brightest image (e.g., the brightness of L255) and the darkest image (e.g., the brightness of L0). A high contrast ratio means that images may be more vivid, black is deeper, and white is brighter, so that the viewing effect and user experience are enhanced. This is particularly important when displaying detail-rich images or when used in bright light environments.

In order to enhance the contrast ratio of a liquid crystal panel, a light-shielding layer is provided most of the time in the pixel structure. However, the light-shielding layer easily causes crosstalk problems between different signals, which not only affects image quality but may also lead to color distortion or other display abnormalities.

### SUMMARY

The disclosure provides a pixel structure capable of reducing crosstalk problems between different signals.

At least one embodiment of the disclosure provides a pixel structure including a substrate, a light-shielding layer, a first insulating layer, a semiconductor layer, a second insulating layer, a first conductive layer, a third insulating layer, and a second conductive layer. The light-shielding layer is located above the substrate and includes a semiconductor layer light-shielding portion, a first data line light-shielding portion, a second data line light-shielding portion, and a third data line light-shielding portion separated from one another. The first insulating layer is located above the light-shielding layer. The semiconductor layer is located above the first insulating layer and at least partially overlaps the semiconductor layer light-shielding portion. The second insulating layer is located above the semiconductor layer. The first conductive layer is located above the second insulating layer and includes a scan line extending in a first direction. The scan line partially overlaps the semiconductor layer. The third insulating layer is located above the first conductive layer. The second conductive layer is located above the third insulating layer and includes a first source/drain, a second source/drain, and a data line. The first source/drain and the second source/drain are connected to the semiconductor layer. The data line is connected to the first source/drain and includes a first extension portion, a second extension portion, and a bent portion. The first extension portion extends in a second direction and overlaps the first data line light-shielding portion. The second extension portion extends in a third direction and overlaps the second data line light-shielding portion. The bent portion connects the first extension portion and the second extension portion and overlaps the third data line light-shielding portion.

At least one embodiment of the disclosure provides a pixel structure including a substrate, a light-shielding layer, a first insulating layer, a semiconductor layer, a second insulating layer, a first conductive layer, a third insulating layer, and a second conductive layer. The light-shielding layer is disposed above the substrate and includes a semiconductor layer light-shielding portion, a first conductive hole light-shielding portion, and a second conductive hole light-shielding portion separated from one another. The first insulating layer is located above the light-shielding layer. The semiconductor layer is located above the first insulating layer and at least partially overlaps the semiconductor layer light-shielding portion. The second insulating layer is located above the semiconductor layer. The first conductive layer is located above the second insulating layer and includes a scan line extending in a first direction. The scan line partially overlaps the semiconductor layer. The third insulating layer is located above the first conductive layer. The second conductive layer is located above the third insulating layer and includes a first source/drain, a second source/drain, and a data line. The first source/drain and the second source/drain are connected to the semiconductor layer. A contact surface between the first source/drain and the semiconductor layer overlaps the first conductive hole light-shielding portion. A contact surface between the second source/drain and the semiconductor layer overlaps the second conductive hole light-shielding portion. The data line is connected to the first source/drain.

To sum up, by dividing the light-shielding layer into a plurality of separated portions, crosstalk between different signals is reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic top view of a pixel structure according to a first example of the disclosure.

FIG. 1B is a schematic cross-sectional view taken along a line A-A′ and a line B-B′ of FIG. 1A.

FIG. 2 is a schematic top view of a pixel structure according to a second example of the disclosure.

FIG. 3 is a schematic top view of a pixel structure according to a third example of the disclosure.

FIG. 4 is a schematic top view of a pixel structure according to a fourth example of the disclosure.

FIG. 5A and FIG. 5B are schematic top views illustrating a crosstalk rate testing method for a liquid crystal display panel according to some embodiments of the disclosure.

### DESCRIPTION OF THE EMBODIMENTS

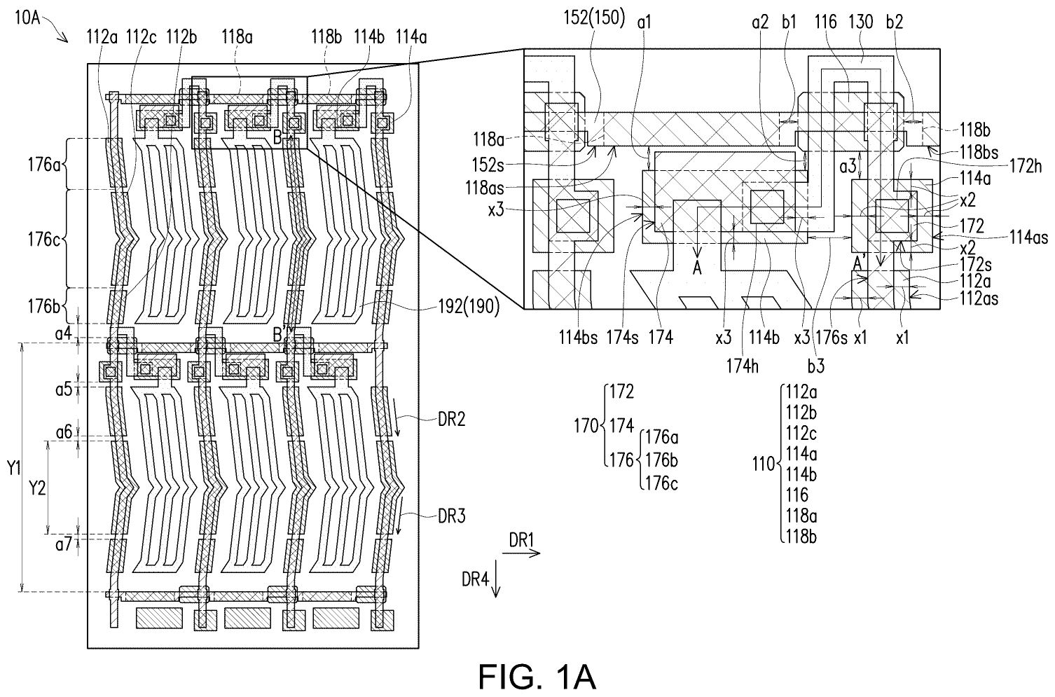

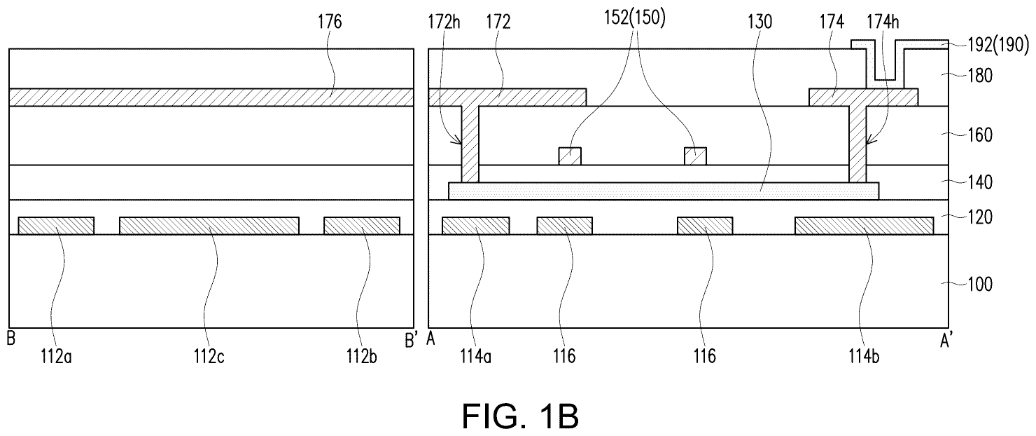

FIG. 1A is a schematic top view of a pixel structure 10A according to a first example of the disclosure. FIG. 1B is a schematic cross-sectional view taken along a line A-A′ and a line B-B′ of FIG. 1A. With reference to FIG. 1A, the pixel structure 10A includes a substrate 100, a light-shielding layer 110, a first insulating layer 120, a semiconductor layer 130, a second insulating layer 140, a first conductive layer 150, a third insulating layer 160, and a second conductive layer 170. In this embodiment, the pixel structure 10A further includes a fourth insulating layer 180 and a pixel electrode layer 190.

The substrate 100 is, for example, a rigid substrate, and a material thereof may be glass, quartz, an organic polymer, an opaque/reflective material (e.g., a conductive material, metal, a wafer, ceramics, or other suitable materials), or other suitable materials. However, the disclosure is not limited thereto, and in other embodiments, the substrate 100 may also be a flexible substrate or a stretchable substrate. For instance, the materials of the flexible substrate and the stretchable substrate include, for example, polyimide (PI), polydimethylsiloxane (PDMS), polyethylene terephthalate (PET), polyethylene naphthalate (PEN), polyester (PES), polymethylmethacrylate (PMMA), polycarbonate (PC), polyurethane (PU), or other suitable materials.

The light-shielding layer 110 is located above the substrate 100. In some embodiments, the light-shielding layer 110 directly contacts a top surface of the substrate 100, but the disclosure is not limited thereto. In other embodiments, a buffer layer, a moisture and gas barrier layer, or other structures are further included between the light-shielding layer 110 and the substrate 100.

The light-shielding layer 110 includes a plurality of portions separated from one another. Specifically, the light-shielding layer 110 includes a plurality of data line light-shielding portions separated from one another (including a first data line light-shielding portion 112a, a plurality of second data line light-shielding portions 112b, and a third data line light-shielding portion 112c), a plurality of scan line light-shielding portions (including a first scan line light-shielding portion 118a and a second scan line light-shielding portion 118b), a plurality of semiconductor layer light-shielding portions 116, a plurality of first conductive hole light-shielding portions 114a, and a plurality of second conductive hole light-shielding portions 114b. In some embodiments, the aforementioned light-shielding portions separated from one another are all floating. In other words, each of the first data line light-shielding portion 112a, the second data line light-shielding portions 112b, the third data line light-shielding portion 112c, the first scan line light-shielding portion 118a, the second scan line light-shielding portion 118b, the semiconductor layer light-shielding portion 116, the first conductive hole light-shielding portions 114a, and the second conductive hole light-shielding portions 114b is not directly connected to other signal sources.

The light-shielding layer 110 has a single-layer structure or a multi-layer structure. In some embodiments, a material of the light-shielding layer 110 includes molybdenum, chromium, tungsten, black resin, other suitable materials, or a combination of the aforementioned materials.

The first insulating layer 120 is located above the light-shielding layer 110 and covers the data line light-shielding portions (including the first data line light-shielding portion 112a, the second data line light-shielding portions 112b, and the third data line light-shielding portion 112c), the scan line light-shielding portions (including the first scan line light-shielding portion 118a and the second scan line light-shielding portion 118b), the semiconductor layer light-shielding portions 116, the first conductive hole light-shielding portions 114a, and the second conductive hole light-shielding portions 114b.

In some embodiments, a material of the first insulating layer 120 includes an inorganic material (e.g., silicon oxide, silicon nitride, silicon oxynitride, hafnium oxide, aluminum oxide, other suitable materials, or a stacked layer of at least two of the aforementioned materials), an organic material, other suitable materials, or a combination of the foregoing.

The semiconductor layer 130 is located above the first insulating layer 120. Each semiconductor layer 130 at least partially overlaps a corresponding semiconductor layer light-shielding portion 116. For instance, each semiconductor layer 130 partially overlaps a corresponding semiconductor layer light-shielding portion 116 in a normal direction of the top surface of the substrate 100. Through such an arrangement, ambient light from a back surface of the substrate 100 may be prevented from illuminating the semiconductor layer 130, so that leakage problems of a thin film transistor are avoided.

The semiconductor layer 130 has a single-layer structure or a multi-layer structure. In some embodiments, the semiconductor layer 130 includes amorphous silicon, polycrystalline silicon, microcrystalline silicon, single crystal silicon, an organic semiconductor material, an oxide semiconductor material (e.g., indium zinc oxide, indium gallium zinc oxide, other suitable materials, or a combination of the aforementioned materials), other suitable materials, or a combination of the aforementioned materials.

The second insulating layer 140 is located above the semiconductor layer 130. In some embodiments, a material of the second insulating layer 140 includes an inorganic material (e.g., silicon oxide, silicon nitride, silicon oxynitride, hafnium oxide, aluminum oxide, other suitable materials, or a stacked layer of at least two of the aforementioned materials), an organic material, other suitable materials, or a combination of the foregoing.

The first conductive layer 150 is located on the second insulating layer 140 and includes a plurality of scan lines 152 extending in a first direction DR1. Each scan line 152 partially overlaps a corresponding one of a plurality of semiconductor layers 130. A portion of the scan line 152 overlapping the semiconductor layer 130 may also be referred to as a gate of a thin film transistor.

The first conductive layer 150 has a single-layer structure or a multi-layer structure. In some embodiments, a material of the first conductive layer 150 includes, for example, metals such as chromium, gold, silver, copper, tin, lead, hafnium, tungsten, molybdenum, neodymium, titanium, tantalum, aluminum, zinc, nickel, alloys thereof, oxides of the aforementioned metals, nitrides of the aforementioned metals, a combination thereof, or other conductive materials.

The scan line light-shielding portions (including the first scan line light-shielding portion 118a and the second scan line light-shielding portion 118b) in the light-shielding layer 110 overlap the scan lines 152 in the first conductive layer 150 in the normal direction of the top surface of the substrate 100. For instance, the first scan line light-shielding portion 118a and the second scan line light-shielding portion 118b are arranged in the first direction DR1 and overlap a corresponding scan line 152. The first scan line light-shielding portion 118a and the second scan line light-shielding portion 118b are separated from each other, and the semiconductor layer light-shielding portion 116 is located between the first scan line light-shielding portion 118a and the second scan line light-shielding portion 118b.

In some embodiments, in the first direction DR1, a distance b1 between the semiconductor layer light-shielding portion 116 and the first scan line light-shielding portion 118a and a distance b2 between the semiconductor layer light-shielding portion 116 and the second scan line light-shielding portion 118b are greater than 0 micrometers and less than or equal to 10 micrometers.

In this embodiment, by separating the semiconductor layer light-shielding portion 116 from the first scan line light-shielding portion 118a and the second scan line light-shielding portion 118b, crosstalk issues between different signals may be reduced. Specifically, the first scan line light-shielding portion 118a and the second scan line light-shielding portion 118b overlap the scan line 152 in the normal direction of the top surface of the substrate 100 without overlapping the semiconductor layer 130. Accordingly, the first scan line light-shielding portion 118a and the second scan line light-shielding portion 118b are coupled almost exclusively to a signal on the scan line 152, so simultaneous coupling to both the signal on the scan line 152 and a signal on the semiconductor layer 130 is avoided. If the first scan line light-shielding portion 118a and the second scan line light-shielding portion 118b are coupled to both the signal on the scan line 152 and the signal on the semiconductor layer 130, crosstalk issues may occur between the signal on the scan line 152 and the signal on the semiconductor layer 130.

In some embodiments, widths of the first scan line light-shielding portion 118a and the second scan line light-shielding portion 118b are greater than or equal to a width of the scan line 152, so that their light-shielding capability for the scan line 152 is improved. In some embodiments, a distance between a side edge 118as of a vertical projection pattern of the first scan line light-shielding portion 118a on the substrate 100 and a side edge 152s of a vertical projection pattern of the scan line 152 on the substrate 100 is greater than or equal to 0 and less than or equal to 10 micrometers, and the second scan line light-shielding portion 118b has a similar arrangement between its side edge 118bs and the scan line 152.

The third insulating layer 160 is located above the first conductive layer 150. In some embodiments, a material of the third insulating layer 160 includes an inorganic material (e.g., silicon oxide, silicon nitride, silicon oxynitride, hafnium oxide, aluminum oxide, other suitable materials, or a stacked layer of at least two of the aforementioned materials), an organic material, other suitable materials, or a combination of the foregoing.

The second conductive layer 170 is located on the third insulating layer 160 and includes a first source/drain 172, a second source/drain 174, and a data line 176. The first source/drain 172 and the second source/drain 174 are connected to the semiconductor layer 130. For instance, the first source/drain 172 and the second source/drain 174 extend through the second insulating layer 140 and the third insulating layer 160 to be connected to the corresponding semiconductor layer 130. A portion of the first source/drain 172 extending through the second insulating layer 140 and the third insulating layer 160 may be referred to as a first conductive hole 172h, and a portion of the second source/drain 174 extending through the second insulating layer 140 and the third insulating layer 160 may be referred to as a second conductive hole 174h. A contact surface between the first source/drain 172 (or the first conductive hole 172h) and the semiconductor layer 130 overlaps the first conductive hole light-shielding portion 114a. A contact surface between the second source/drain 174 (or the second conductive hole 174h) and the semiconductor layer 130 overlaps the second conductive hole light-shielding portion 114b.

In some embodiments, the first conductive hole light-shielding portion 114a and the second conductive hole light-shielding portion 114b are arranged in the first direction DR1. In some embodiments, in the first direction DR1, a distance b3 between the first conductive hole light-shielding portion 114a and the second conductive hole light-shielding portion 114b is greater than 0 micrometers and less than or equal to 10 micrometers.

In some embodiments, in a direction perpendicular to the first direction DR1 (e.g., a fourth direction DR4 in the figure), a distance a3 between the semiconductor layer light-shielding portion 116 and the first conductive hole light-shielding portion 114a, a distance a2 between the semiconductor layer light-shielding portion 116 and the second conductive hole light-shielding portion 114b, and a distance al between the second conductive hole light-shielding portion 114b and the first scan line light-shielding portion 118a are greater than 0 micrometers and less than or equal to 10 micrometers.

In this embodiment, by making the first conductive hole light-shielding portion 114a and the second conductive hole light-shielding portion 114b independent from each other and separated from other light-shielding portions in the light-shielding layer 110, crosstalk issues between different signals may be reduced.

In some embodiments, a distance x2 between at least one side edge 114as of a vertical projection pattern of the first conductive hole light-shielding portion 114a on the substrate 100 and at least one side edge 172s of a vertical projection pattern of the first source/drain 172 on the substrate 100 is greater than or equal to 0 and less than or equal to 10 micrometers. The first conductive hole light-shielding portion 114a extending beyond at least one side edge 172s is beneficial for enhancing the shielding capability of the first conductive hole light-shielding portion 114a for the first source/drain 172.

In some embodiments, a distance x3 between at least one side edge 114bs of a vertical projection pattern of the second conductive hole light-shielding portion 114b on the substrate 100 and at least one side edge 174s of a vertical projection pattern of the second source/drain 174 on the substrate 100 is greater than or equal to 0 and less than or equal to 10 micrometers. The second conductive hole light-shielding portion 114b extending beyond at least one side edge 174s is beneficial for enhancing the shielding capability of the second conductive hole light-shielding portion 114b for the second source/drain 174.

The data line 176 is connected to the first source/drain 172. In this embodiment, the data line 176 and the first source/drain 172 are connected integrally. In some embodiments, the data line 176 includes a first extension portion 176a, a second extension portion 176b, and a bent portion 176c. The first extension portion 176a extends in a second direction DR2, the second extension portion 176b extends in a third direction DR3 that is not parallel to the second direction DR2, and the bent portion 176c connects the first extension portion 176a and the second extension portion 176b. In some embodiments, a plurality of first extension portions 176a and a plurality of second extension portions 176b are arranged in an alternating manner, so that the data line 176 extends in a fourth direction DR4 as a whole.

The first extension portion 176a, the second extension portion 176b, and the bent portion 176c overlap the first data line light-shielding portion 112a, the second data line light-shielding portion 112b, and the third data line light-shielding portion 112c, respectively.

In some embodiments, in the fourth direction DR4, a distance a5 between the first conductive hole light-shielding portion 114a and the first data line light-shielding portion 112a, a distance a6 between the first data line light-shielding portion 112a and the third data line light-shielding portion 112c, a distance a7 between the third data line light-shielding portion 112c and the second data line light-shielding portion 112b, and a distance a4 between the second data line light-shielding portion 112b and another semiconductor layer light-shielding portion 116 are greater than 0 micrometers and less than or equal to 10 micrometers.

In this embodiment, by separating the first conductive hole light-shielding portion 114a, the first data line light-shielding portion 112a, the second data line light-shielding portion 112b, the third data line light-shielding portion 112c, and the semiconductor layer light-shielding portion 116, crosstalk issues between different signals may be reduced. Specifically, light-shielding portions located in different regions may generate coupling with different signal lines. Therefore, by segmenting multiple light-shielding portions corresponding to the same data line 176, signals on the aforementioned different signal lines (e.g., signals on different scan lines 152) may be prevented from interfering with each other through the light-shielding portions.

For instance, the first data line light-shielding portion 112a, the second data line light-shielding portion 112b, and the third data line light-shielding portion 112c overlap the data line 176 in the normal direction of the top surface of the substrate 100 without overlapping the scan line 152. Accordingly, the first data line light-shielding portion 112a, the second data line light-shielding portion 112b, and the third data line light-shielding portion 112c are coupled almost only to the signal on the data line 176, so that coupling to both the signal on the data line 176 and the signal on the scan line 152 is avoided.

In some embodiments, a width of the first data line light-shielding portion 112a, a width of the second data line light-shielding portion 112b, and a width of the third data line light-shielding portion 112c are respectively greater than or equal to a width of the first extension portion 176a, a width of the second extension portion 176b, and a width of the bent portion 176c, so that light-shielding capability thereof for the data line 176 is enhanced. In some embodiments, a distance x1 between a side edge 112as of a vertical projection pattern of the first data line light-shielding portion 112a on the substrate 100 and a side edge 176s of a vertical projection pattern of the data line 176 on the substrate 100 is greater than or equal to 0 and less than or equal to 10 micrometers. The second data line light-shielding portion 112b and the third data line light-shielding portion 112c have similar arrangements.

In some embodiments, a spacing between two adjacent scan lines 152 is Y1, where the spacing Y1 may also be referred to as a length of one sub-pixel. In some embodiments, a length Y2 of the third data line light-shielding portion 176c in a direction perpendicular to the first direction DR1 (i.e., the fourth direction DR4) is greater than or equal to 2 micrometers and less than or equal to 0.9 times of Y1.

The fourth insulating layer 180 is located above the second conductive layer 170. In some embodiments, a material of the fourth insulating layer 180 includes an inorganic material (e.g., silicon oxide, silicon nitride, silicon oxynitride, hafnium oxide, aluminum oxide, other suitable materials, or a stacked layer of at least two of the aforementioned materials), an organic material, other suitable materials, or a combination of the foregoing.

The pixel electrode layer 190 is located on the fourth insulating layer 180 and includes a plurality of pixel electrodes 192. Each pixel electrode 192 is electrically connected to a corresponding second source/drain 174.

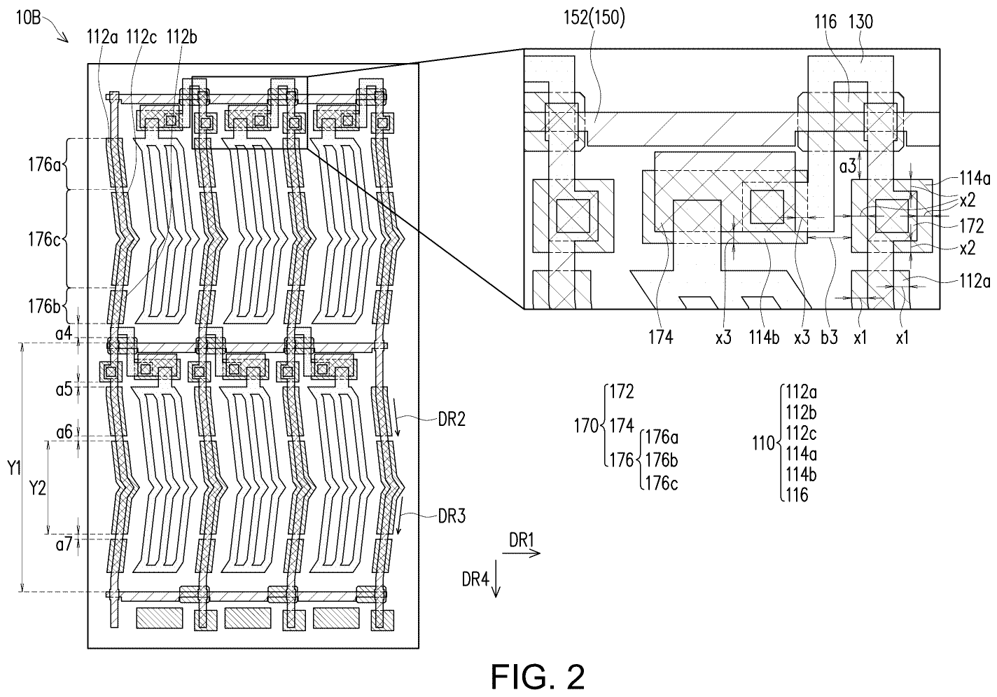

In some embodiments, liquid crystal molecules (not shown) are further included above the pixel electrode 192, and a direction of the liquid crystal molecules may be controlled by an electric field between a common electrode (not shown) and the pixel electrode 192. FIG. 2 is a schematic top view of a pixel structure 10B according to a second example

of the disclosure. It should be mentioned herein that the reference numerals and part of the content provided in the embodiments shown in FIG. 1A and FIG. 1B are applied in the embodiments shown in FIG. 2, where the same or similar reference numerals serve to denote the same or similar components, and the description of the same technical content is omitted. For the description of the omitted parts, please refer to the previous embodiments, and the description is not repeated herein.

The difference between the pixel structure 10B of FIG. 2 and the pixel structure 10A of FIG. 1A is that: in the pixel structure 10B, the light-shielding layer 110 does not include scan line light-shielding portions (e.g., the first scan line light-shielding portion 118a and the second scan line light-shielding portion 118b).

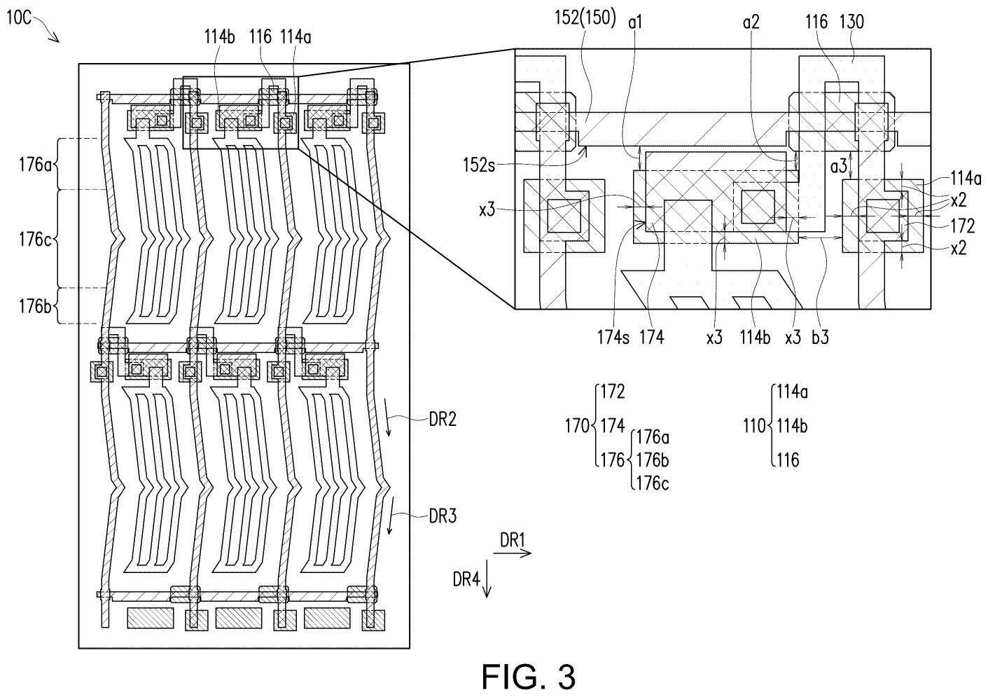

FIG. 3 is a schematic top view of a pixel structure 10C according to a third example of the disclosure. It should be mentioned herein that the reference numerals and part of the content provided in the embodiments shown in FIG. 1A and FIG. 1B are applied in the embodiments shown in FIG. 3, where the same or similar reference numerals serve to denote the same or similar components, and the description of the same technical content is omitted. For the description of the omitted parts, please refer to the previous embodiments, and the description is not repeated herein.

The difference between the pixel structure 10C of FIG. 3 and the pixel structure 10A of FIG. 1A is that: in the pixel structure 10C, the light-shielding layer 110 does not include the first scan line light-shielding portion 118a, the second scan line light-shielding portion 118b, the first data line light-shielding portion 112a, the second data line light-shielding portion 112b, and the third data line light-shielding portion 112c.

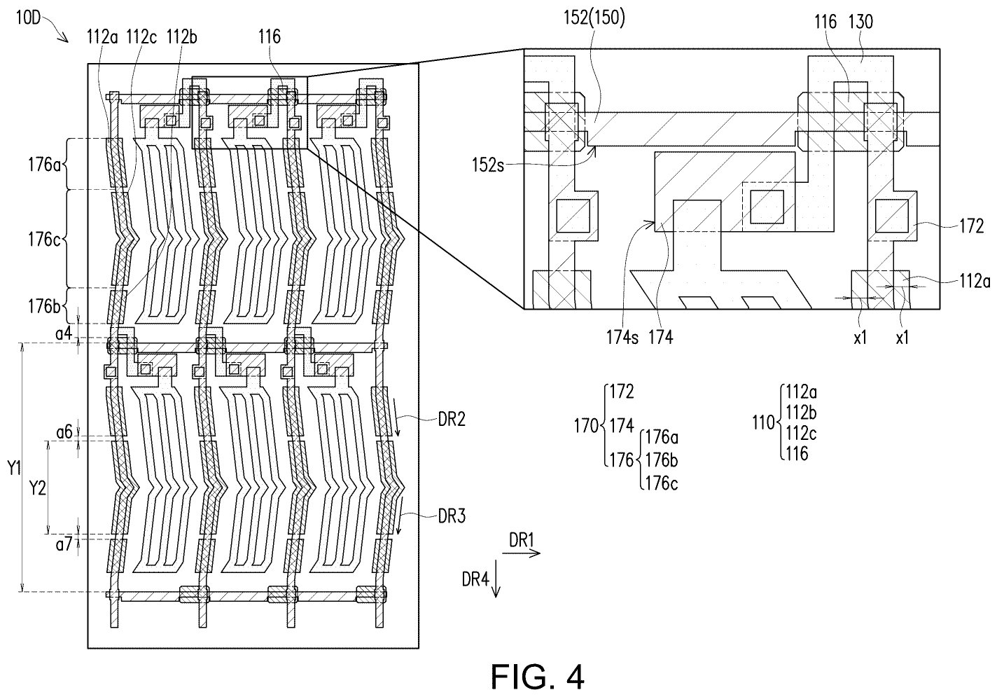

FIG. 4 is a schematic top view of a pixel structure 10D according to a fourth example of the disclosure. It should be mentioned herein that the reference numerals and part of the content provided in the embodiments shown in FIG. 1A and FIG. 1B are applied in the embodiments shown in FIG. 4, where the same or similar reference numerals serve to denote the same or similar components, and the description of the same technical content is omitted. For the description of the omitted parts, please refer to the previous embodiments, and the description is not repeated herein.

The difference between the pixel structure 10D of FIG. 4 and the pixel structure 10A of FIG. 1A is that: in the pixel structure 10D, the light-shielding layer 110 does not include the first scan line light-shielding portion 118a, the second scan line light-shielding portion 118b, the first conductive hole light-shielding portion 114a, and the second conductive hole light-shielding portion 114b.

A contrast ratio and a crosstalk rate of a liquid crystal display device including the pixel structure of the first example (refer to FIG. 1A) are measured. A contrast ratio and a crosstalk rate of a liquid crystal display device including the pixel structure of the second example (refer to FIG. 2) are measured. A contrast ratio and a crosstalk rate of a liquid crystal display device including the pixel structure of the third example (refer to FIG. 3) are measured. A contrast ratio and a crosstalk rate of a liquid crystal display device including the pixel structure of the fourth example (refer to FIG. 4) are measured.

A contrast ratio and a crosstalk rate of a liquid crystal display device including a pixel structure of a comparative example are measured. In the comparative example, the pixel structure in the liquid crystal display device is similar to the pixel structures of the first to fourth examples, with the only difference being that the light-shielding layer of the pixel structure of the comparative example only includes the semiconductor layer light-shielding portion without other light-shielding portions. The contrast ratios and crosstalk rates of the liquid crystal display devices corresponding to the comparative example and the first to fourth examples are shown in Table 1.

TABLE 1

| | Comparative | First | Second | Third | Fourth |
|---|---|---|---|---|---|
| | Example | Example | Example | Example | Example |
| Central contrast ratio | 1408 | 1437 | 1431 | 1369 | 1407 |
| ID 19 contrast ratio | 685 | 742 | 720 | 704 | 701 |
| Crosstalk rate | 0.39% | 0.31% | 0.27% | 0.56% | 0.15% |

In Table 1, the central contrast ratio refers to the contrast ratio of the liquid crystal display

panel at a normal viewing angle. The ID 19 contrast ratio refers to selecting four points on the liquid crystal display panel, comparing the contrast ratios of these four points, and selecting the minimum value. The aforementioned four points are respectively located at positions where the tilt angle (theta angle) is 42.5 degrees and the azimuth angle (phi angle) is 156.6 degrees, the tilt angle is 42.5 degrees and the azimuth angle is 23.5 degrees, the tilt angle is 40.6 degrees and the azimuth angle is 191.9 degrees, and the tilt angle is 40.6 degrees and the azimuth angle is 348.2 degrees.

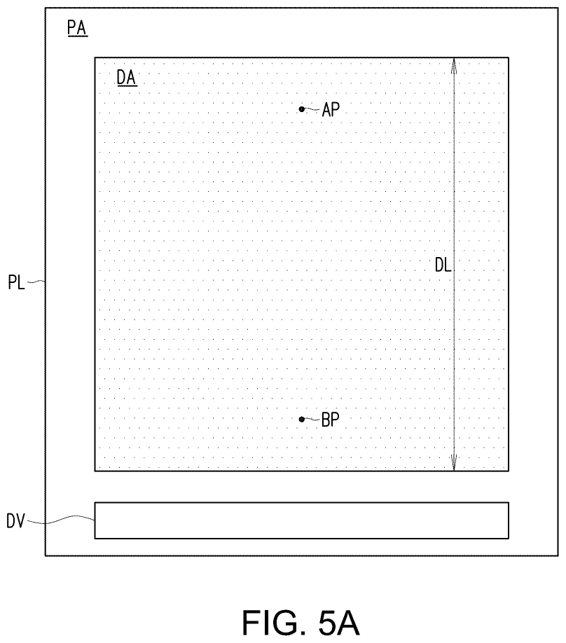

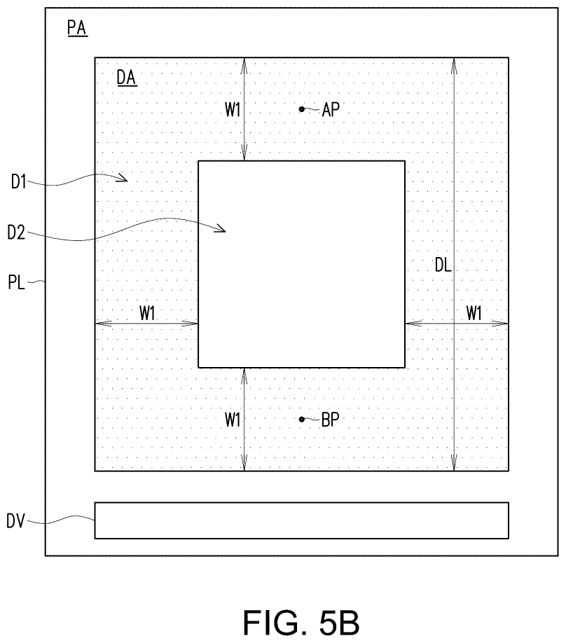

The calculation method of the crosstalk rate in Table 1 may be explained together with FIG. 5A and FIG. 5B. A liquid crystal display panel PL includes a display region DA and a peripheral region PA. The display region DA includes a plurality of pixel structures (e.g., the plurality of pixel structures as shown in FIG. 1A to FIG. 4). The display region DA has a length DL, where the length DL is, for example, a linear distance from one side of the display region DA close to a driving circuit DV to another side of the display region DA away from the driving circuit DV. The peripheral region PA includes the driving circuit DV (e.g., a chip, a gate driving circuits, etc.).

Points AP and BP are selected on the liquid crystal display panel PL, where the point AP is located at a position ⅛ of the length DL downward from a top end of a centerline of the display region DA, and the point BP is located at a position ⅛ of the length DL upward from a bottom end of the centerline of the display region DA. First, brightness of the entire display region DA of the liquid crystal display panel PL is adjusted to L128, and actual brightness of the points AP and BP is measured, as shown in FIG. 5A. The actual brightness of the point AP at this time is AP′, and the actual brightness of the point BP at this time is BP′. Next, the brightness of the peripheral region D1 of the display region DA is adjusted to L128, the brightness of the central region D2 of the display region DA is adjusted to L256, and the actual brightness of the points AP and BP is measured, as shown in FIG. 5B. The actual brightness of the point AP at this time is AP″, and the actual brightness of the point BP at this time is BP″. A width W1 of the peripheral region D1 is approximately ¼ of the length DL.

The crosstalk rate at the point AP is Abs(AP′-AP″)/AP′, and the crosstalk rate at the point BP is Abs (BP′-BP″)/BP′, where Abs represents an absolute value. The larger of the two is the crosstalk rate shown in Table 1.

From Table 1, it can be known that by providing other light-shielding portions in addition to the semiconductor layer light-shielding portion in the light-shielding layer, the central contrast ratio and the ID 19 contrast ratio may be effectively improved. In addition, since the light-shielding portions in the light-shielding layer in the first to fourth examples are separated from one another, the crosstalk rate is prevented from increasing, and the crosstalk rate is maintained below 1%.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A pixel structure, comprising:
a substrate;
a light-shielding layer located above the substrate and comprising a semiconductor layer light-shielding portion, a first data line light-shielding portion, a second data line light-shielding portion, and a third data line light-shielding portion separated from one another;
a first insulating layer located above the light-shielding layer;
a semiconductor layer located above the first insulating layer and at least partially overlapping the semiconductor layer light-shielding portion;
a second insulating layer located above the semiconductor layer;
a first conductive layer located above the second insulating layer and comprising:
a scan line extending in a first direction and partially overlapping the semiconductor layer;
a third insulating layer located above the first conductive layer; and
a second conductive layer located above the third insulating layer and comprising:
a first source/drain and a second source/drain connected to the semiconductor layer; and
a data line connected to the first source/drain and comprising:
a first extension portion extending in a second direction and overlapping the first data line light-shielding portion;
a second extension portion extending in a third direction and overlapping the second data line light-shielding portion; and
a bent portion connecting the first extension portion and the second extension portion and overlapping the third data line light-shielding portion.

2. The pixel structure according to claim 1, wherein a width of the first data line light-shielding portion is greater than or equal to a width of the first extension portion, and a width of the second data line light-shielding portion is greater than or equal to a width of the second extension portion.

3. The pixel structure according to claim 1, wherein the light-shielding layer further comprises a first conductive hole light-shielding portion and a second conductive hole light-shielding portion, wherein a contact surface between the first source/drain and the semiconductor layer overlaps the first conductive hole light-shielding portion, and a contact surface between the second source/drain and the semiconductor layer overlaps the second conductive hole light-shielding portion.

4. The pixel structure according to claim 1, wherein the first conductive layer comprises a plurality of scan lines extending in the first direction, wherein a spacing between adjacent two of the scan lines is Y1, and a length of the third data line light-shielding portion in a direction perpendicular to the first direction is greater than or equal to 2 micrometers and less than or equal to 0.9 times of Y1.

5. The pixel structure according to claim 1, wherein a distance between the first data line light-shielding portion and the third data line light-shielding portion and a distance between the second data line light-shielding portion and the third data line light-shielding portion are greater than 0 micrometers and less than or equal to 10 micrometers.

6. The pixel structure according to claim 1, wherein the first data line light-shielding portion, the second data line light-shielding portion, and the third data line light-shielding portion do not overlap the scan line in a normal direction of a top surface of the substrate.

7. The pixel structure according to claim 1, wherein the light-shielding layer further comprises a first scan line light-shielding portion and a second scan line light-shielding portion overlapping the scan line, wherein the first scan line light-shielding portion is separated from the second scan line light-shielding portion.

8. The pixel structure according to claim 1, wherein the semiconductor layer light-shielding portion, the first data line light-shielding portion, the second data line light-shielding portion, and the third data line light-shielding portion are all floating.

9. The pixel structure according to claim 1, wherein a material of the light-shielding layer comprises molybdenum, chromium, tungsten, black resin, or a combination of the above materials.

10. A pixel structure, comprising:
a substrate;
a light-shielding layer disposed above the substrate and comprising a semiconductor layer light-shielding portion, a first conductive hole light-shielding portion, and a second conductive hole light-shielding portion separated from one another;
a first insulating layer located above the light-shielding layer;
a semiconductor layer located above the first insulating layer and at least partially located on the semiconductor layer light-shielding portion;
a second insulating layer located above the semiconductor layer;
a first conductive layer located above the second insulating layer and comprising:
a scan line extending in a first direction and partially overlapping the semiconductor layer;
a third insulating layer located above the first conductive layer; and
a second conductive layer located above the third insulating layer and comprising:
a first source/drain connected to the semiconductor layer, wherein a contact surface between the first source/drain and the semiconductor layer overlaps the first conductive hole light-shielding portion;
a second source/drain connected to the semiconductor layer, wherein a contact surface between the second source/drain and the semiconductor layer overlaps the second conductive hole light-shielding portion; and
a data line connected to the first source/drain.

11. The pixel structure according to claim 10, wherein the light-shielding layer further comprises a first scan line light-shielding portion and a second scan line light-shielding portion overlapping the scan line, wherein the first scan line light-shielding portion is separated from the second scan line light-shielding portion.

12. The pixel structure according to claim 11, wherein the semiconductor layer light-shielding portion is located between the first scan line light-shielding portion and the second scan line light-shielding portion, wherein in the first direction, a distance between the semiconductor layer light-shielding portion and the first scan line light-shielding portion, a distance between the semiconductor layer light-shielding portion and the second scan line light-shielding portion, and a distance between the first conductive hole light-shielding portion and the second conductive hole light-shielding portion are greater than 0 micrometers and less than or equal to 10 micrometers.

13. The pixel structure according to claim 11, wherein in a direction perpendicular to the first direction, a distance between the semiconductor layer light-shielding portion and the first conductive hole light-shielding portion, a distance between the semiconductor layer light-shielding portion and the second conductive hole light-shielding portion, and a distance between the second conductive hole light-shielding portion and the first scan line light-shielding portion are greater than 0 micrometers and less than or equal to 10 micrometers.

14. The pixel structure according to claim 11, wherein widths of the first scan line light-shielding portion and the second scan line light-shielding portion are greater than or equal to a width of the scan line.

15. The pixel structure according to claim 11, wherein a distance between a side edge of a vertical projection pattern of the first scan line light-shielding portion on the substrate and a side edge of a vertical projection pattern of the scan line on the substrate is greater than or equal to 0 and less than or equal to 10 micrometers, wherein a distance between at least one side edge of a vertical projection pattern of the first conductive hole light-shielding portion on the substrate and at least one side edge of a vertical projection pattern of the first source/drain on the substrate is greater than or equal to 0 and less than or equal to 10 micrometers, wherein a distance between at least one side edge of a vertical projection pattern of the second conductive hole light-shielding portion on the substrate and at least one side edge of a vertical projection pattern of the second source/drain on the substrate is greater than or equal to 0 and less than or equal to 10 micrometers.

16. The pixel structure according to claim 11, wherein the first scan line light-shielding portion and the second scan line light-shielding portion are both floating.

17. The pixel structure according to claim 10, wherein the light-shielding layer comprises a plurality of data line light-shielding portions separated from one another, and the data line overlaps the data line light-shielding portions.

18. The pixel structure according to claim 10, wherein a material of the light-shielding layer comprises molybdenum, chromium, tungsten, black resin, or a combination of the above materials.
